(19) United States
(12) Patent Application Publication
(10) Pub. No.: US 2018/0167093 A1
(43) Pub. Date: Jun. 14, 2018

(54) DISTORTION COMPENSATION APPARATUS AND DISTORTION COMPENSATION METHOD

(71) Applicant: FUJITSU LIMITED, Kawasaki-shi (JP)

(72) Inventors: Shunji MIYAZAKI, Kawasaki (JP); Hiroyoshi ISHIKAWA, Kawasaki (JP)

(73) Assignee: FUJITSU LIMITED, Kawasaki-shi (JP)

(21) Appl. No.: 15/819,824

(22) Filed: Nov. 21, 2017

(30) Foreign Application Priority Data
Dec. 9, 2016 (JP) 2016-239832

(51) Int. Cl. H04B 1/04; H04B 17/10

(52) U.S. Cl. CPC H04B 1/0475; H04B 2001/0408; H04B 17/101

(57) ABSTRACT

There is provided a distortion compensation apparatus for compensating a distortion of a power amplifier configured to amplify a transmission signal, the distortion compensation apparatus including a memory, and a processor coupled to the memory and the processor configured to acquire an average power of the transmission signal including a plurality of signal blocks by a signal block of the plurality of signal blocks, calculate a step coefficient value based on the acquired average power, and update a distortion compensation coefficient for compensating the distortion, based on an updating amount according to the calculated step coefficient value.

### CROSS-REFERENCE TO RELATED APPLICATION

This application is based upon and claims the benefit of priority of the prior Japanese Patent Application No. 2016-239832, filed on Dec. 9, 2016, the entire contents of which are incorporated herein by reference.

### FIELD

The embodiments discussed herein are related to a distortion compensation apparatus and a distortion compensation method.

### BACKGROUND

As the speed of wireless communication increases, the bandwidth and dynamic range of transmission signals have been increased. Under such circumstances, in order to minimize the deterioration of signal quality, high linearity is required for a power amplifier. That is, in order to achieve both linearity and power conversion efficiency, a power amplifier having high power conversion efficiency is operated even in a nonlinear region and a nonlinear distortion occurring at that time is compensated by a distortion compensator. A pre-distortion method (hereinafter, referred to as a “PD method”), which is one type of distortion compensation used in the distortion compensator, is a technique for increasing the linearity of output of the power amplifier by multiplying the inverse characteristic of the nonlinear distortion of the power amplifier to the transmission signal in advance.

Related techniques are disclosed in, for example, Japanese Patent No. 4308163.

Related techniques are disclosed in, for example, S. Haykin, “Adaptive Filter Theory”, Prentice-Hall, Englewood Cliffs, N.J., 1991.

### SUMMARY

According to an aspect of the invention, a distortion compensation apparatus for compensating a distortion of a power amplifier configured to amplify a transmission signal, the distortion compensation apparatus includes a memory, and a processor coupled to the memory and the processor configured to acquire an average power of the transmission signal including a plurality of signal blocks by a signal block of the plurality of signal blocks, calculate a step coefficient value based on the acquired average power, and update a distortion compensation coefficient for compensating the distortion, based on an updating amount according to the calculated step coefficient value.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a view illustrating the basic configuration of a distortion compensator according to an embodiment;

FIG. 2 is a view illustrating the configuration of a transmission signal in the embodiment;

FIG. 3 is a flowchart illustrating the basic operation of the distortion compensator according to the embodiment;

FIG. 4 is a view illustrating a specific configuration of the distortion compensator according to the embodiment;

FIGS. 5A to 5C are waveform diagrams illustrating a specific operation of the distortion compensator according to the embodiment;

FIG. 6 is a flowchart illustrating a specific operation of the distortion compensator according to the embodiment;

FIG. 7 is a view illustrating a specific configuration of a distortion compensator according to a first modification;

FIG. 8 is a flowchart illustrating a specific operation of the distortion compensator according to the first modification;

FIG. 9 is a view illustrating a specific configuration of a distortion compensator according to a second modification;

FIG. 10 is a flowchart illustrating a specific operation of the distortion compensator according to the second modification;

FIG. 11 is a view illustrating a specific configuration of a distortion compensator according to a third modification;

FIGS. 12A to 12C are waveform diagrams showing a specific operation of the distortion compensator according to the third modification;

FIG. 13 is a flowchart illustrating a specific operation of the distortion compensator according to the third modification; and

FIG. 14 is a view illustrating one example of hardware of a distortion compensator.

### DESCRIPTION OF EMBODIMENTS

When a coefficient value used for updating a distortion compensation coefficient (step coefficient) in a distortion compensator is fixed, the distortion compensation coefficient may vary substantially so as not to be converged, which may result in a deterioration of distortion compensation performance.

An embodiment of a distortion compensator capable of suppressing the deterioration of distortion compensation performance will be described in detail below with reference to the accompanying drawings. It should be noted that the disclosed technology is not limited by the embodiment. Throughout the description and the drawings, elements having same functions are denoted by same reference numerals and explanation thereof will not be repeated.

### Embodiment

A distortion compensator according to an embodiment will be described. In a base station of a wireless communication system, when a transmission signal is amplified by a power amplifier, the nonlinearity of the power amplifier may fluctuate over time. The distortion compensator adopts a digital pre-distortion (DPD) technique which performs distortion compensation of non-stationary data according to the output of the power amplifier so as to adaptively compensate the nonlinearity of the power amplifier when amplifying the transmission signal with the power amplifier.

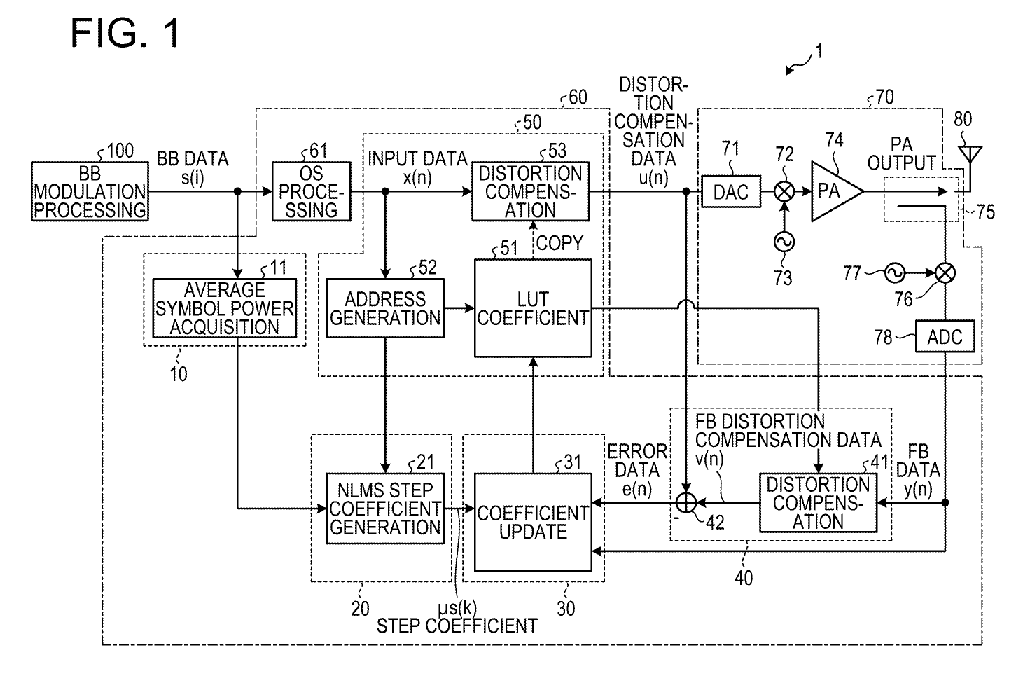

For example, as illustrated in FIG. 1, a distortion compensator 1 includes a baseband (BB) modulation processing unit 100, a radio frequency (RF) digital unit 60, an RF analog unit 70, and an antenna 80. The RF digital unit 60 includes an oversampling (OS) processing unit 61, a compensating unit 50, a feedback unit 40, and an updating unit 30. The RF analog unit 70 includes a digital-analog converter (DA converter) 71, a mixer 72, an oscillator 73, a power amplifier (PA) 74, a coupler 75, a mixer 76, an oscillator 77, and an analog-digital converter (ADC) 78. FIG. 1 is a view illustrating the basic configuration of the distortion compensator 1.

The BB modulation processing unit 100 performs baseband modulation on desired data and outputs BB (baseband) data s(i) to the RF digital unit 60. Here, the BB data s(i) is complex symbol data and is symbol data at discrete timings. The symbol i represents a sample timing.

The RF digital unit 60 receives the BB data s(i) from the BB modulation processing unit 100 and receives feedback (FB) data y(n) from the RF analog unit 70. The RF digital unit 60 performs distortion compensation on the BB data s(i) based on the FB data y(n) to generate distortion compensation data u(n) which is then output to the RF analog unit 70.

For example, the OS processing unit 61 includes an FIR filter and oversamples the BB data s(i) output from the BB modulation processing unit 100 through a band limiting and interpolating process by the FIR filter. The OS processing unit 61 outputs input data x(n) to the compensating unit 50. The input data x(n) is complex symbol data and is symbol data at discrete timings. The symbol n represents a sample timing at intervals smaller than i.

The band of the transmission signal may be limited to a band that maximizes the frequency components of the output data (sample) from the BB modulation processing unit 100 and a Nyquist frequency determined by a sampling interval. In the meantime, distortion of PA 74 may occur beyond bandwidth. Therefore, in order to perform distortion compensation in a digital manner, a wider bandwidth may be expressed by reducing the sampling interval by an oversampling process.

The compensating unit 50 utilizes a distortion compensation coefficient (LUT coefficient) to perform a distortion compensating process on the input data x(n) subjected to the oversampling process by the OS processing unit 61. The distortion compensation coefficient is a coefficient that compensates for the distortion of the power amplifier that amplifies the transmission signal, and is set in the compensating unit 50. The compensating unit 50 outputs a result of the distortion compensating process, as the distortion compensation data u(n), to the DAC 71 and the feedback unit 40.

The RF analog unit 70 receives the distortion compensation data u(n), which is a digital baseband signal, from the RF digital unit 60. The RF analog unit 70 performs an RF process to convert the distortion compensation data u(n) into an electromagnetic wave signal to be transmitted from the antenna 80 to the air.

For example, the DAC 71 performs DA conversion of the distortion compensation data u(n) (digital signal) into a distortion compensation signal (analog signal) and supplies the distortion compensation signal to the mixer 72. The mixer 72 modulates the distortion compensation signal (baseband signal) to generate an RF signal. That is, the mixer 72 multiplies the distortion compensation signal by a local signal of a predetermined frequency from the oscillator 73 to up-convert the frequency of the distortion compensation signal from a baseband frequency to an RF frequency. The mixer 72 supplies the up-converted distortion compensation signal to the PA 74. The PA 74 amplifies the power of the distortion compensation signal and outputs the amplified signal to the antenna 80.

In addition, a portion of the output signal of the PA 74 is fed back (FB). The coupler 75 is electromagnetically coupled to the output side of the PA 74 and may extract the portion of the output signal of the PA 74 (a feedback signal corresponding to the output of the PA 74) and supply the extracted portion of the output signal to the mixer 76. The mixer 76 demodulates the feedback signal to generate a baseband signal. That is, the mixer 76 multiplies a local signal of a predetermined frequency from the oscillator 77 to the feedback signal to down-convert the frequency of the feedback signal from an RF frequency to a baseband frequency. The mixer 76 supplies the down-converted feedback signal to the ADC 78. The ADC 78 AD-converts the feedback signal (analog signal) into the FB data y(n) (digital signal) and supplies the FB data y(n) to the feedback unit 40 and the updating unit 30.

The feedback unit 40 receives the distortion compensation data u(n) from the compensating unit 50 and receives the FB data y(n) from the RF analog unit 70. The feedback unit 40 generates error data e(n) based on the distortion compensation data u(n) and the FB data y(n) and supplies the generated error data e(n) to the updating unit 30.

The updating unit 30 receives the FB data y(n) from the RF analog unit 70 and receives the error data e(n) from the feedback unit 40. The updating unit 30 accesses the compensating unit 50 to update the distortion compensation coefficient set in the compensating unit 50 based on the FB data y(n) and the error data e(n).

The distortion compensator 1 adaptively updates the distortion compensation coefficient. For example, the compensating unit 50 includes a look-up table (LUT) 51, an address generating unit 52, and a distortion compensating unit 53. The feedback unit 40 includes a distortion compensating unit 41 and a subtractor 42. The updating unit 30 includes a coefficient updater 31.

The LUT 51 stores information in which addresses and LUT coefficients are associated with each other. The address generating unit 52 generates an address of the LUT 51 corresponding to a distortion compensation coefficient to be copied onto the distortion compensating unit 53 according to the amplitude of the input data x(n). The LUT 51 copies the distortion compensation coefficient corresponding to the address generated by the address generating unit 52 onto the distortion compensating unit 53 and supplies the distortion compensation coefficient to the distortion compensating unit 41. The distortion compensating unit 53 multiplies the input data x(n) by the distortion compensation coefficient copied from the LUT 51 to generate the distortion compensation data u(n) and outputs the distortion compensation data u(n) to the DAC 71 and the subtractor 42.

In the meantime, the distortion compensating unit 41 multiplies the FB data y(n) by the distortion compensation coefficient supplied from the LUT 51 to generate FB distortion compensation data v(n), and outputs the FB distortion compensation data v(n) to the subtractor 42. The subtractor 42 calculates a difference between the distortion compensation data u(n) and the FB distortion compensation data v(n) and outputs the difference, as the error data e(n), to the coefficient updater 31. That is, the error data e(n) represents an error between the distortion compensation DPD1 by the distortion compensating unit 53 and the distortion compensation DPD2 by the distortion compensating unit 41. The DPD1 and the DPD2 may be performed in parallel in real time.

The coefficient updater 31 calculates an update value of the distortion compensation coefficient according to the error data e(n). For example, the coefficient updater 31 calculates an update value of the distortion compensation coefficient so that the power of the error data e(n) becomes minimal. The coefficient updater 31 accesses the address determined by the address generating unit 52 in the LUT 51 at a predetermined timing and updates a value of the distortion compensation coefficient corresponding to the address to the calculated update value. Thereby, each distortion compensation coefficient in the LUT 51 may be adaptively updated.

Next, a DPD process in the distortion compensator 1 will be described in detail using mathematical equations.

The PA (power amplifier) 74 has a saturation characteristic in a high power region in which a nonlinear distortion occurs in a signal when the PA 74 is operated. When the high power region may be utilized, the PA 74 may be operated with high efficiency to reduce the overall operation power of the distortion compensator 1, thereby achieving a significant power reduction effect. For this purpose, the DPD is a process of compensating for a distortion of the input signal of the PA 74 so that the input/output of the PA 74 has a linear response as a whole.

The distortion compensator 1 utilizes an adaptive DPD to estimate a coefficient of an inverse characteristic model by feeding back a portion of a signal output from the PA 74 and reflect the result of the estimation on a distortion compensation coefficient used for DPD of the transmission signal. The DPD of this type is also called an indirect learning (IDL) method. The IDL method estimates a coefficient of an inverse characteristic model (DPD2) by feeding back a signal according to an output of the PA 74 and copies a result of the estimation every predetermined timing. Then, this method performs a distortion compensating process of the transmission signal (DPD1).

In this specification, for the sake of specific description, the IDL method is used consistently. However, explanation may be made similarly using a direct learning (DL) method in most cases.

From a mathematical point of view, the characteristics of DPD are modeled as a nonlinear function representing a data input/output response. The PA 74 serving as an object may have a memory effect. That is, the PA 74 may be affected not only by an input signal at an output timing (n) but also by a signal at a somewhat delayed timing.

In a case where the PA 74 may be affected by a signal not only at the output timing (n) but also at the delayed timing, a Volterra series model may be used as a model for expressing a distortion compensation effect of DPD. Here, for the sake of simplicity, the generalized memory polynomial model which is a limited version of the Volterra series model is further used. Here, assuming that the series order of nonlinearity and the delay amount are terminated with a finite number in terms of implementation, the distortion compensation data u(n) may be expressed by the following Equation 1.

$$u ( n ) = {\sum }_{k = 1}^{K} {\sum }_{j = 0}^{Q} {\sum }_{i = 0}^{Q} {h}_{i , j , k} {\vert x ( n - i ) \vert}^{k - 1} x ( n - j ) \qquad ( 1 )$$

In Equation (1), Q represents the maximum timing of a delayed signal and K represents the maximum series order.

When the generalized memory polynomial model is implemented as it is, the power of input data is required to be computed, which may lead to increase in the amount of processing and circuit scale. In order to avoid this, the generalized memory polynomial model is made into a nonlinear function and the series part included in the model is held as an LUT. That is, the distortion compensation data u(n) obtained from the distortion compensation (DPD1) of the distortion compensating unit 53 with respect to the input data x(n) may be expressed by the following Equation 2.

$$u ( n ) = {\sum }_{j = 0}^{Q} ( {\sum }_{i = 0}^{Q} {L}_{i , j} ( \vert x ( n - i ) \vert ) ) x ( n - j ) \qquad ( 2 )$$

As a result, the power calculation for the series is erased and the generalized memory polynomial model may be implemented with the sum of LUT coefficients L_{i,j} (i is an integer from 0 to Q and j is an integer from 0 to Q) and one product operation per input signal (equivalent to linear filtering).

Further, the FB distortion compensation data v(n) obtained from the distortion compensation (DPD2) of the distortion compensating unit 41 with respect to the FB data y(n) may be expressed by the following Equation 3.

$$v ( n ) = {\sum }_{j = 0}^{Q} ( {\sum }_{i = 0}^{Q} {L}_{i , j} ( \vert x ( n - i ) \vert ) ) y ( n - j ) \qquad ( 3 )$$

In Equation (3), the LUT coefficient L_{i,j} is determined depending on |x(n−i)| rather than |y(n−i)|.

Here, the correspondence relationship between the power series and the LUT may be expressed by the following Equation (4).

$${L}_{i , j} ( \vert x ( n - i ) \vert ) = {\sum }_{k = 1}^{K} {h}_{i , j , k} {\vert x ( n - i ) \vert}^{k - 1} \qquad ( 4 )$$

However, once expressed as LUT by L_{i,j}(|x(n−i)|), it is not bound by the information that it was originally represented by the power series on the right side. L_{i,j}(|x(n−i)|) is considered to correspond to any nonlinear function dependent on |x(n−i)|.

As they are, Equations (2) and (3) are merely expressions of replacing a series function with a general nonlinear function. In the LUT method, this nonlinear function is literally held as a LUT by a buffer memory. Each address of the buffer memory may be defined by associating the address with a discrete index from a continuous signal |x(n−i)|.

Other several methods are conceivable, but here, as an example, equal-spaced quantization is performed on an amplitude value for a range of signals estimated in advance in accordance with a prescribed buffer size.

In order for distinguishing between the actual amplitude and the corresponding address for clarification, a mapping function such as iₐ=iₐ(|x(n−i)|) is used. However, unless there is no misunderstanding, |x(n−i)| itself represents the corresponding address itself. In other words, L_{i,j}(|x(n−i)|) in the LUT means an element of an address corresponding to |x(n−i)|.

The LUT 51 illustrated in FIG. 1 sets an LUT coefficient so that u(n)=x(n) in order to initialize the distortion compensating process. Accordingly, the LUT 51 sets an initial value of the LUT coefficient, as illustrated in the following Equations (5) and (6).

L_{0,0}(|x(n)|)=1 (5)

L_{i,j}(|x(n)|)=0 when i≠0 or j≠0 (6)

At any sample timing (n), elements L_{i,j}(|x(n−i)|) (i and j=0, 1, . . . , Q) of the LUT coefficient depending on the amplitudes |x(n)|, |x(n−)|, . . . , |x(n−Q)| of input data x(n), x(n−1), . . . , x(n−Q) at this sample timing are updated.

A coefficient updating amount ΔL_{i,j} is estimated depending on the FB data y(n), y(n−1), . . . , y(n−Q) and an error signal corresponding to the input signal. The coefficient of interest is updated with a simple cumulative sum. That is, the coefficient updater 31 calculates an update value L_{i,j}(|x(n−i)|′ of the LUT coefficient for each of i,j=0, 1, . . . , Q according to the following Equation (7).

L_{i,j}(|x(n−i)|′=L_{i,j}(|x(n−i)|′+ΔL_{i,j} (7)

Here, as a method for generating the coefficient updating amount ΔL_{i,j}, a Least Mean Square (LMS) method and a Normalized Least Mean Square (NLMS) method will be examined. The LMS method and the NLMS method are methods designed on the premise that they are statistically applied to stationary data. These methods are attempted to be applied to non-stationary data. Here, it is assumed that at least an average value (the first moment of the statistical quantity) of the non-stationary data varies with time. For example, consider a case where the data is formatted by a defined signal block, is statistically stationary within the signal block, and is characterized by constant average power.

In the LMS method, for each of i,j=0, 1, . . . , Q, the coefficient updating amount ΔL_{i,j} is generated by a calculation expressed by the following Equation (8).

ΔL_{i,j}=μ·e(n)·y(n−j)* (8)

In Equation (8), μ is called a step coefficient and may be set to a fixed value. When the value of μ is fixed, there is a possibility that the distortion compensation coefficient has a fluctuation so great that it may not converge. For example, in a plurality of signal blocks, when the FB data y(n−j) greatly changes, its complex conjugate value y(n−j)* also greatly fluctuates. As a result, as illustrated in Equation (8), since the value of the coefficient updating amount Δ_{Li,j} greatly fluctuates, there is a possibility that the distortion compensation coefficient to be updated has a fluctuation too great to converge.

In addition, in the NLMS method, for each of i,j=0, 1, . . . , Q, the coefficient updating amount ΔL_{i,j} is generated by a calculation expressed by the following Equation (9). In order to converge the distortion compensation coefficient faster than the LMS method, the NLMS method generates the coefficient updating amount ΔL_{i,j} normalized by the power (|x(n−k)|²) of the input data obtained for each signal block.

$$Δ {L}_{i , j} = μ \cdot e ( n ) \frac{{y ( n - j )}^{*}}{\frac{1}{{N}_{Q}} {\sum }_{k = - Q}^{Q} {\vert x ( n - k ) \vert}^{2}} \qquad ( 9 )$$

In Equation (9), μ is called a step coefficient and may be set to a fixed value. When the value of μ is fixed, there is a possibility that the distortion compensation coefficient has a fluctuation so great that it may not converge. For example, in a plurality of signal blocks, when the power (|x(n−k)|²) of the input data greatly changes, the coefficient updating amount ΔL_{i,j} also greatly fluctuates. Therefore, there is a possibility that the distortion compensation coefficient to be updated has a substantial fluctuation so as not to converge.

If the distortion compensation coefficient has a substantial fluctuation so as not to converge, the distortion compensation performance may be deteriorated. For example, when the PA 74 continues to operate while the input/output characteristic remains nonlinear, the adjacent channel leakage power ratio (ACLR) of signal transmission may be deteriorated. The deteriorated ACLR may have a significant effect on communication performed on adjacent channels, which may result in deterioration of communication quality.

Therefore, in the embodiment, in the distortion compensator 1, the average power of transmission signal obtained for each signal block is used to scale the value of a step coefficient μₛ(k) so that the coefficient updating amount ΔL_{i,j} becomes constant. Then, the distortion compensation coefficient L_{i,j} is updated with the coefficient updating amount Δ_{Li,j} obtained from the step coefficient μₛ(k), thereby suppressing deterioration of the distortion compensation performance.

Specifically, as illustrated in FIG. 1, the RF digital unit 60 further includes an acquiring unit 10 and a calculating unit 20. The transmission signal includes a plurality of signal blocks. The acquiring unit 10 acquires the average power of the transmission signal on a signal block basis and supplies the acquired average power of the transmission signal to the calculating unit 20.

The calculating unit 20 utilizes the average power of the transmission signal to calculate the value of the step coefficient μₛ(k). The calculating unit 20 scales and calculates the value of the step coefficient μₛ(k) so that the coefficient updating amount ΔL_{i,j} becomes substantially uniform among the plurality of signal blocks. The calculating unit 20 supplies the calculated value of the step coefficient μₛ(k) to the updating unit 30.

The updating unit 30 obtains the coefficient updating amount ΔL_{i,j} according to the value of the step coefficient μₛ(k). The updating unit 30 updates the LUT coefficient (distortion compensation coefficient) L_{i,j} with the obtained coefficient updating amount ΔL_{i,j}. The updating unit 30 updates the LUT coefficient (distortion compensation coefficient) L_{i,j} with the coefficient updating amount ΔL_{i,j} at a timing corresponding to the boundary of the plurality of signal blocks.

Here, each signal block indicates the unit of a signal for which the average power is obtained, and may be set to an arbitrary size in the transmission signal as long as it is the unit suitable for obtaining the average power.

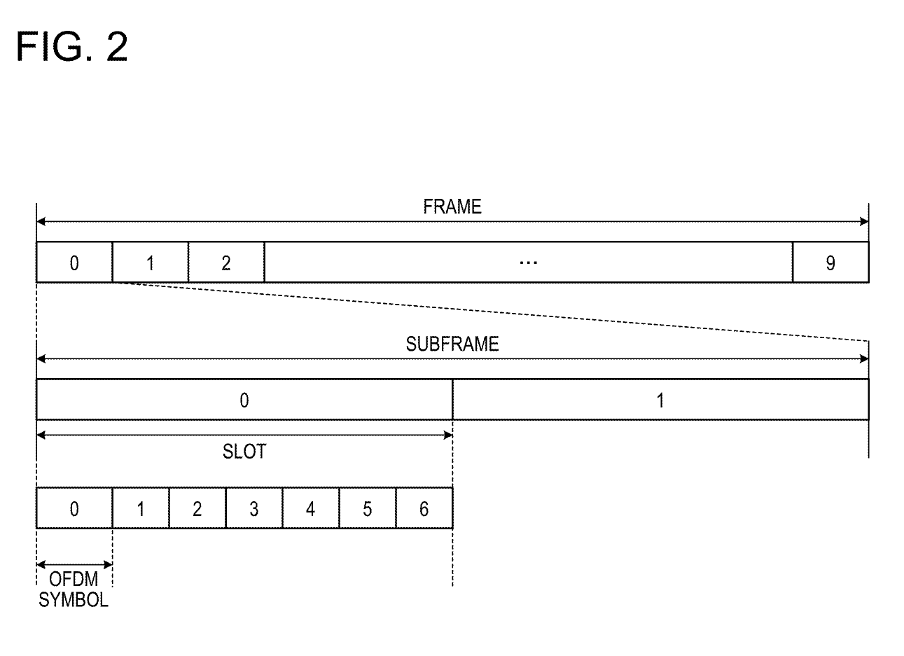

The transmission signal may be configured according to arbitrary communication specifications. For example, the transmission signal has a configuration illustrated in FIG. 2 when the transmission signal is configured based on LTE which is the standardized specification of mobile communication systems. FIG. 2 illustrates the configuration of a transmission signal. As a format of the transmission signal, a down link (DL) signal of frequency division duplex (FDD) of LTE may be assumed. For example, each processing unit may be defined in the order from the largest one as follows. 1. Frame: 10 ms unit. 2. Subframe: 1 ms unit, 1 frame=10 subframes. 3. Slot: 0.5 ms unit, 1 subframe=2 slot. 4. OFDM symbol (including Cyclic Prefix (CP)): 1 slot=7 OFDM symbol.

At this time, a signal block as the unit of a signal for which the average power is obtained may be a frame, a subframe, a slot or an OFDM symbol, as illustrated in FIG. 2. The following description will be given with an assumption that a signal block is an OFDM symbol.

The acquiring unit 10 includes an average symbol power acquiring unit 11. The calculating unit 20 includes a step coefficient calculating unit 21. The average symbol power acquiring unit 11 acquires the average power of the transmission signal in the unit of signal block (OFDM symbol unit) and supplies the acquired average power of the transmission signal to the step coefficient calculating unit 21. The step coefficient calculating unit 21 calculates a step coefficient corresponding to the average power for each signal block unit (OFDM symbol unit).

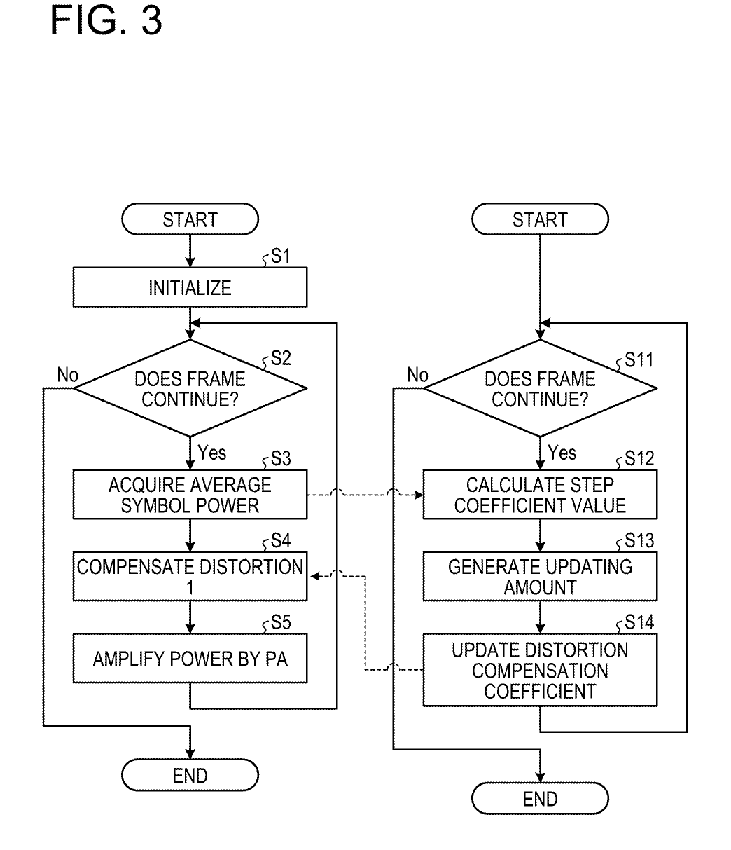

Further, the distortion compensator 1 operates as illustrated in FIG. 3. FIG. 3 is a flowchart illustrating the basic operation of the distortion compensator 1.

In the distortion compensator 1, the operations (S1 to S5) by the acquiring unit 10, the compensating unit 50, and the PA 74 and the operations (S11 to S14) by the calculating unit 20 and the updating unit 30 are performed in parallel. The compensating unit 50 performs an initialization operation of the distortion compensation process to set an initial value of the LUT coefficient as illustrated in Equations (5) and (6) (S1). When it is determined that a frame continues (“Yes” in S2), the acquiring unit 10 acquires a value corresponding to the average power of the transmission signal in the signal block unit (OFDM symbol unit) and supplies the acquired average power of the transmission signal to the calculating unit 20 (S3).

When it is determined that a frame continues (“Yes” in S11), the calculating unit 20 calculates the value of the step coefficient μₛ(k) based on the value corresponding to the average power of the transmission signal (S12) and supplies the calculated value of the step coefficient μₛ(k) to the updating unit 30.

The updating unit 30 obtains the coefficient updating amount ΔL_{i,j} corresponding to the value of the step coefficient μₛ(k) (S13). The updating unit 30 accesses the LUT 51 to update the LUT coefficient (distortion compensation coefficient) L_{i,j} with the obtained coefficient updating amount ΔL_{i,j} (S14).

The compensating unit 50 performs the distortion compensating process using the updated LUT coefficient (distortion compensation coefficient) L_{i,j} (S4), generates the distortion compensation data u(n), and outputs the generated distortion compensation data u(n) to the PA 74 via the DAC 71 and the mixer 72. The PA 74 amplifies the power of a distortion compensation signal corresponding to the distortion compensation data u(n) (S5).

The operation loop of S2 to S5 is repeated until the frame of the transmission signal does not continue (“Yes” in S2), and is ended when it is determined that the frame of the transmission signal does not continue (“No” in S2). Similarly, the operation loop of S11 to S14 is repeated until the frame of the transmission signal does not continue (“Yes” in S11), and is ended when it is determined that the frame of the transmission signal does not continue (“No” in S11).

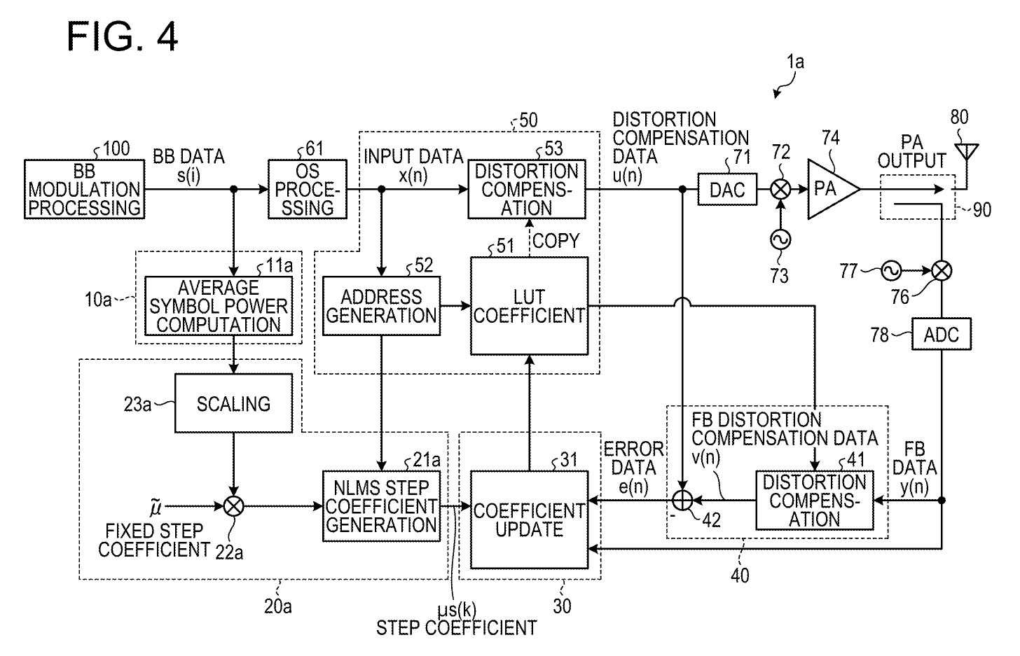

Next, a more specific configuration example of a distortion compensator 1a in the case where the NLMS method is adopted as a method for generating the coefficient updating amount ΔL_{i,j} will be described with reference to FIG. 4 which is a view illustrating a specific configuration of the distortion compensator 1a. Referring to FIG. 4, the distortion compensator 1a includes an arithmetic unit 10a and a calculating unit 20a as specific configuration examples of the acquiring unit 10 and the calculating unit 20 (see, e.g., FIG. 1). The arithmetic unit 10a includes an average symbol power arithmetic unit 11a. The calculating unit 20a includes an NLMS step coefficient generating unit 21a, a multiplier 22a, and a scaling unit 23a.

The average symbol power arithmetic unit 11a receives BB data s(i) from the BB modulation processing unit 100. The average symbol power arithmetic unit 11a obtains the average power for each signal block (OFDM symbol) with respect to the BB data s(i). The average power of the BB data s(i) corresponds to the average power of the input data x(n). For example, the average symbol power arithmetic unit 11a may obtain the average power for the BB data s(i) in a period ranging from a head sample timing n(k) of the k-th OFDM symbol to a prescribed sample number Nₐᵥ, as illustrated in the following Equation (10). The period ranging from the head sample timing n(k) to the prescribed sample number Nₐᵥ may be equal to or shorter than an OFDM symbol period.

$${\vert s \vert}^{2} {n ( k )}_{} = \frac{1}{{N}_{av}} {\sum }_{m = n ( k )}^{n ( k ) + {N}_{av}} {\vert s ( m ) \vert}^{2} \qquad ( 10 )$$

However, the average symbol power arithmetic unit 11a may measure the power of the OFDM symbol corresponding to data stored as the FB data y(n) in the buffer and hold the measured powers in the buffer. The average symbol power arithmetic unit 11a supplies the obtained average power to the scaling unit 23a.

The scaling unit 23a obtains a scaling value mₛ(k) illustrated in the following Equation (11) before the head data of the k-th OFDM symbol interval with respect to the FB data y(n) begins.

$${m}_{s} ( k ) = \sqrt{\frac{ {\vert s \vert}^{2} {n ( k )}_{}}{{P}_{ref}}} \qquad ( 11 )$$

In Equation (11), P_{ref} represents the reference power. That is, the scaling unit 23a obtains the scaling value mₛ(k) according to the relative value of the average power <|s|²>ₙ₍ₖ₎ of the k-th OFDM symbol with respect to the value of the reference power P_{ref}, according to the NLMS method. The reference power P_{ref} may be the maximum value of the average power among a plurality of signal blocks (a plurality of OFDM symbols). For example, in Equation (11), assuming that the head OFDM symbol in a frame is the maximum power, P_{ref} may be expressed by the following Equation (12).

P_{ref}=<|s|²>ⁿ⁽⁰⁾ (12)

The scaling unit 23a may fixedly use the reference power P_{ref} represented by Equation (12) for OFDM symbols after the head OFDM symbol. The scaling unit 23a may use the reference power P_{ref} represented by Equation (12) to obtain the scaling value mₛ(k) illustrated in Equation (11) for the k-th OFDM symbol.

The multiplier 22a receives a fixed step coefficient (fixed coefficient value) ˜μ and receives the scaling value mₛ(k) from the scaling unit 23a. The multiplier 22a multiplies the fixed step coefficient ˜μ by the scaling value mₛ(k) to obtain the value of the step coefficient μₛ(k), as illustrated in the following Equation (13).

μₛ(k)=\tilde{μ}×mₛ(k) (13)

That is, the calculating unit 20a scales and calculates the scaling value mₛ(k) so as to make the coefficient updating amount ΔL_{i,j} substantially equal among the plurality of signal blocks. The multiplier 22a supplies the calculated scaling value mₛ(k) to the NLMS step coefficient generating unit 21a. The NLMS step coefficient generating unit 21a associates an address generated by the address generating unit 52 with the value of the step coefficient μₛ(k). The NLMS step coefficient generating unit 21a supplies the step coefficient μₛ(k) associated with the address to the coefficient updater 31 of the updating unit 30.

The coefficient updater 31 generates the coefficient updating amount ΔL_{i,j} by performing a calculation expressed by the following Equation (14) instead of Equation (9).

$$Δ {L}_{i , j} = {μ}_{s} ( k ) \cdot e ( n ) \frac{{y ( n - j )}^{*}}{\frac{1}{{N}_{Q}} {\sum }_{k = - Q}^{Q} {\vert x ( n - k ) \vert}^{2}} \qquad ( 14 )$$

The calculation illustrated in Equation (14) is different from the calculation illustrated in Equation (9) in that the step coefficient μₛ(k) is variable. The coefficient updater 31 obtains the update value L_{i,j}(|x(n−i)|)′ of the LUT coefficient for each of i,j=0, 1, . . . , Q by performing the calculation illustrated in Equation (7).

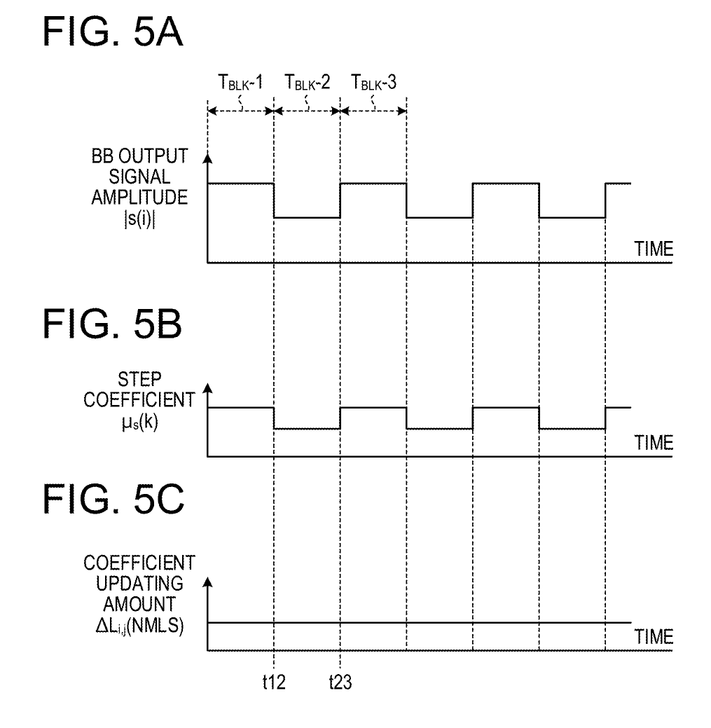

In the distortion compensator 1a, a scaling dependent on the average power is performed on the fixed step coefficients ˜μ on a signal block basis to change the value of the step coefficient μₛ(k). That is, as illustrated in FIGS. 5A to 5C, the value of the step coefficient μₛ(k) is changed so as to make the coefficient updating amount ΔL_{i,j} substantially constant. FIGS. 5A to 5C are waveform diagrams illustrating a specific operation of the distortion compensator 1a.

As illustrated in Equation (11), the calculating unit 20a obtains the scaling value mₛ(k) according to the relative value of the average power |s|² of the BB data s(i) with respect to the value of the reference power P_{ref}. Then, as illustrated in Equation (13), the calculating unit 20a multiplies the fixed step coefficient ˜μ by the scaling value mₛ(k) to obtain the value of the step coefficient μₛ(k).

When the amplitude |s(i)| of the BB data s(i) output from the BB modulation processing unit 100 is changed as illustrated in FIG. 5A, the scaling value mₛ(k) increases as the amplitude |s(i)| becomes larger, as illustrated in Equation (11). The scaling value mₛ(k) decreases as the amplitude |s(i)| becomes smaller, as illustrated in Equation (11). Therefore, the value of the step coefficient μₛ(k) is changed as illustrated in FIG. 5B in such a manner that the value of the step coefficient μₛ(k) increases as the amplitude |s(i)| becomes larger and decreases as the amplitude |s(i)| becomes smaller, as illustrated in Equation (13).

For example, in a period T_{BLK}-1 corresponding to the first signal block, the arithmetic unit 10a computes the average power of the first signal block and the calculating unit 20a calculates the value of the step coefficient μₛ(k) based on the average power. At a timing t12 corresponding to the boundary between the first signal block and the second signal block, the updating unit 30 updates the distortion compensation coefficient with the updating amount corresponding to the value of the step coefficient μₛ(k). Thereafter, in a period T_{BLK}-2 corresponding to the second signal block, the arithmetic unit 10a computes the average power of the second signal block and the calculating unit 20a calculates the value of the step coefficient μₛ(k) based on the average power. At a timing t23 corresponding to the boundary between the second signal block and the third signal block, the updating unit 30 updates the distortion compensation coefficient with the updating amount corresponding to the value of the step coefficient μₛ(k).

That is, depending on the average power of a signal block computed in a period corresponding to the signal block, the value of the step coefficient μₛ(k) may be changed at a timing corresponding to the boundary between signal blocks immediately after the signal block. As a result, as illustrated in Equations (11) and (14), since the power for normalizing the coefficient updating amount ΔL_{i,j} is substantially maintained at the value of the reference power P_{ref}, the coefficient updating amount ΔL_{i,j} may be maintained substantially constant, as illustrated in FIG. 5C.

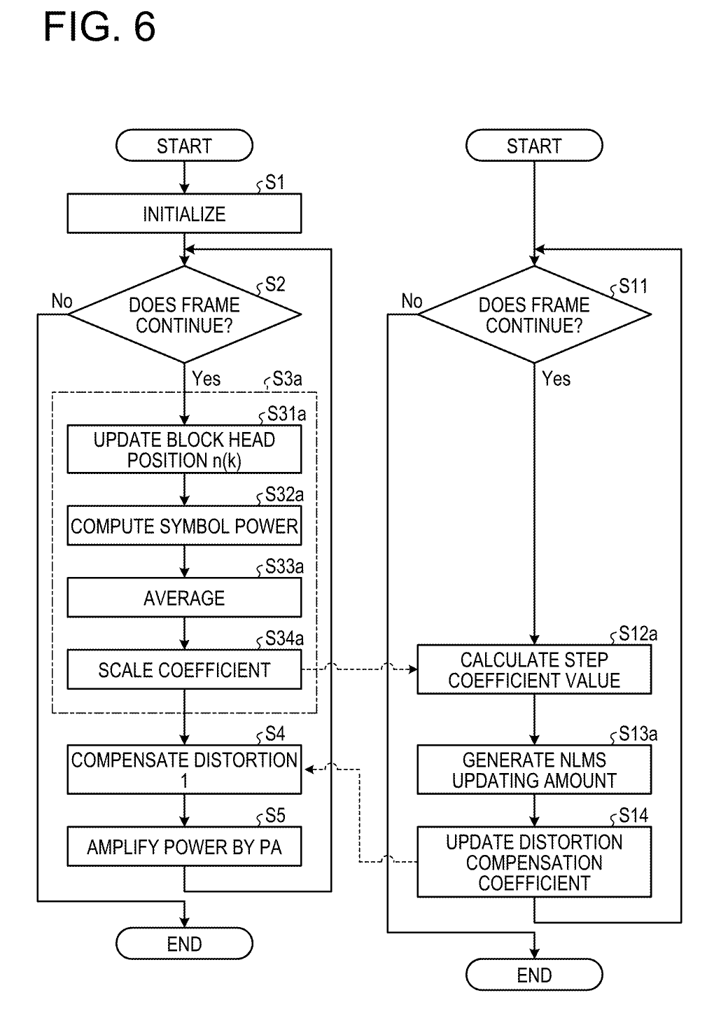

In addition, the distortion compensator 1a performs an operation as illustrated in FIG. 6 as a specific operation example. FIG. 6 is a flowchart illustrating a specific operation of the distortion compensator 1a.

Referring to the flowchart of FIG. 6, as a specific operation example of the average symbol power acquisition (S3), the step coefficient value calculation (S13), and the updating amount generation (S14) (see FIG. 3), average symbol power computation (S3a), step coefficient value calculation (S12a), and NLMS updating amount generation (S13a) are performed.

In the average symbol power computation (S3a), upon obtaining the BB data s(i) of the k-th signal block, the arithmetic unit 10a updates the head position of a signal block from n(k−1) to n(k) (S31a) and computes the power |s|₂of the k-th signal block (S32a). As illustrated in Equation (10), the arithmetic unit 10a averages the computed power |s|² for the predetermined sample number Nₐᵥ from the head position n(k) to obtain the average power <|s|²>ₙ₍ₖ₎ (S33a) and supplies the obtained average power <|s|²>ₙ₍ₖ₎ to the calculating unit 20a. The arithmetic unit 10a uses the average power <|s|²>ₙ₍ₖ₎ to obtain the scaling value mₛ(k), as illustrated in Equation (11), and supplies the obtained scaling value mₛ(k) to the calculating unit 20a (S34a).

When it is determined that a frame continues (“Yes” in S11), the calculating unit 20a multiplies the fixed step coefficient ˜μ by the scaling value mₛ(k) to calculate the value of the step coefficient μₛ(k) (S12a). The calculating unit 20a supplies the calculated value of the step coefficient μₛ(k) to the updating unit 30.

As illustrated in Equation (14), according to the NLMS method, the updating unit 30 obtains the coefficient updating amount ΔL_{i,j} corresponding to the value of the step coefficient μₛ(k) (S13a). The updating unit 30 accesses the LUT 51 to update the LUT coefficient (distortion compensation coefficient) L_{i,j} with the obtained coefficient updating amount ΔL_{i,j} (S14).

As described above, in the embodiment, in the distortion compensator 1 (the distortion compensator 1a), the average power of the transmission signal obtained for each signal block is used to scale the value of the step coefficient μₛ(k) so as to make the coefficient updating amount ΔL_{i,j} constant. Then, the distortion compensation coefficient L_{i,j} is updated with the coefficient updating amount ΔL_{i,j} obtained from the step coefficient μₛ(k). Accordingly, when the power of the transmission signal (the power of the input data) is substantially changed, the variation of the coefficient updating amount ΔL_{i,j} may be suppressed, thereby suppressing the variation of the distortion compensation coefficient to be updated. As a result, the distortion compensation coefficient may be easily converged to an expected convergence value, thereby suppressing deterioration of the distortion compensation performance. For example, the characteristics of ACLR may be improved, thereby suppressing deterioration of communication quality.

In the embodiment, in the distortion compensator 1 (the distortion compensator 1a), the average power value of the transmission signal is acquired on a signal block basis and the step coefficient μₛ(k) is changed at a timing corresponding to the boundary between signal blocks based on the acquired average power value. As a result, it is possible to quickly follow the change in power of the transmission signal (power of the input data) to suppress the variation of the coefficient updating amount ΔL_{i,j}.

First Modification

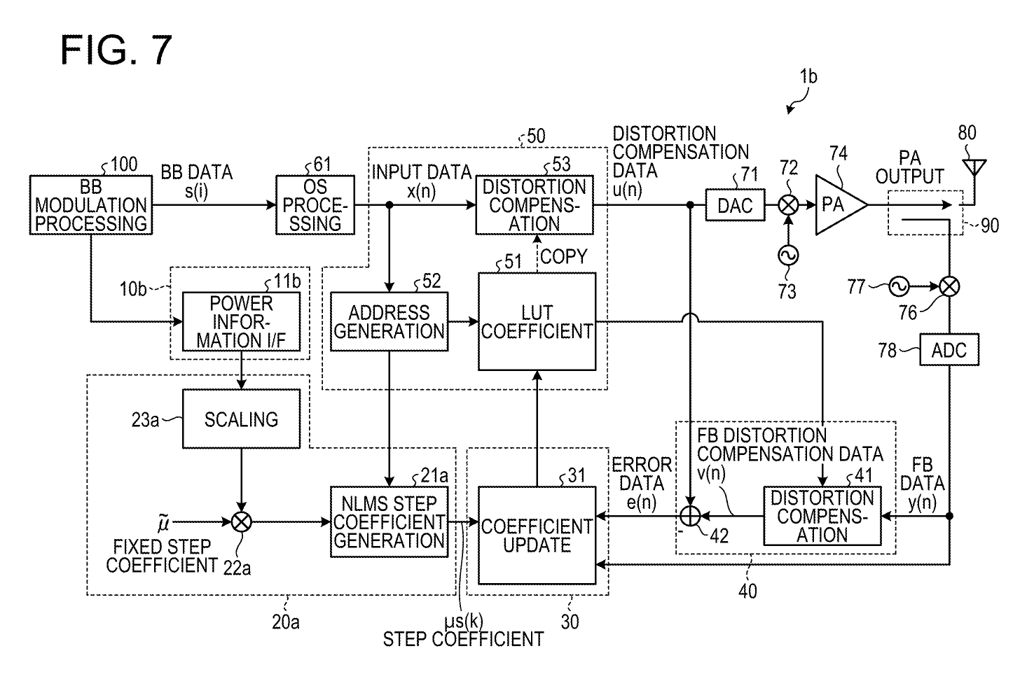

The distortion compensator 1b may acquire the average power of a signal block on a signal block basis by acquiring power information indicating the average power. For example, as illustrated in FIG. 7, the distortion compensator 1b may include an acquiring unit 10b as a specific configuration example of the acquiring unit 10 (see, e.g., FIG. 1). The acquiring unit 10b includes power information I/F 11b.

When performing baseband modulation on desired data to generate the BB data s(i), the BB modulation processing unit 100 obtains the average power of the BB data s(i) and holds information indicating the average power. Therefore, the power information I/F 11b may acquire the power information indicating the average power of the BB data s(i) from the BB modulation processing unit 100. The power information I/F 11b may specify the average power for each signal block according to the power information.

For example, when specifying the average power P(k) of the k-th signal block (k-th OFDM symbol) according to the power information, the power information I/F 11b supplies the average power P(k) to the scaling unit 23a.

The scaling unit 23a obtains the scaling value mₛ(k) illustrated in the following Equation 15 before the head data of the k-th OFDM symbol interval with respect to the FB data y(n) begins.

$${m}_{s} ( k ) = \sqrt{\frac{P ( k )}{{P}_{ref}}} \qquad ( 15 )$$

In Equation (15), P_{ref} represents the reference power. The reference power P_{ref} may be the maximum value of the average power among a plurality of signal blocks (a plurality of OFDM symbols). For example, in Equation (15), assuming that the head OFDM symbol in a frame is the maximum power, P_{ref} may be expressed by the following Equation (12).

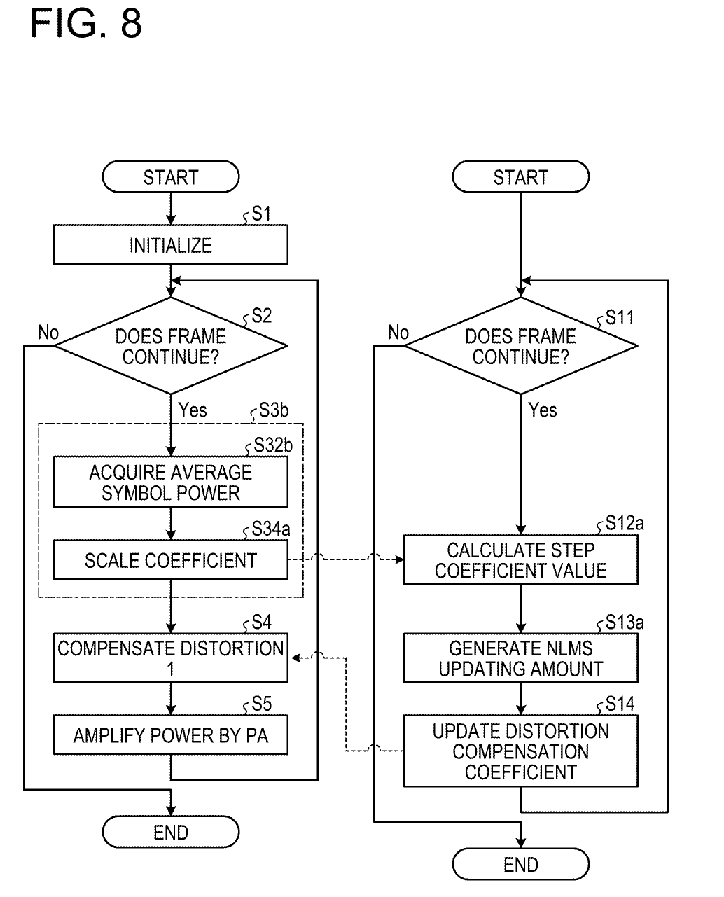

In addition, the distortion compensator 1b performs an operation as illustrated in FIG. 8 as a specific operation example. FIG. 8 is a flowchart illustrating a specific operation of the distortion compensator 1b.

In FIG. 8, the average symbol power computation (S3a) in the process illustrated in FIG. 6 is replaced with average symbol power acquisition (S3b). In the average symbol power acquisition (S3b), when acquiring the power information, the acquiring unit 10b specifies the average power P(k) of the k-th signal block according to the power information (S32b) and supplies the specified average power P(k) of the k-th signal block to the calculating unit 20a. The acquiring unit 10b uses the average power P(k) to obtain the scaling value mₛ(k), as illustrated in Equation (15), and supplies the obtained scaling value mₛ(k) to the calculating unit 20a (S34a).

In this way, since the distortion compensator 1b acquires the average power of the signal block on a signal block basis by acquiring the power information indicating the average power, the configuration and process of the acquiring unit 10b may be simplified, as compared to a case of computing the average power.

Second Modification

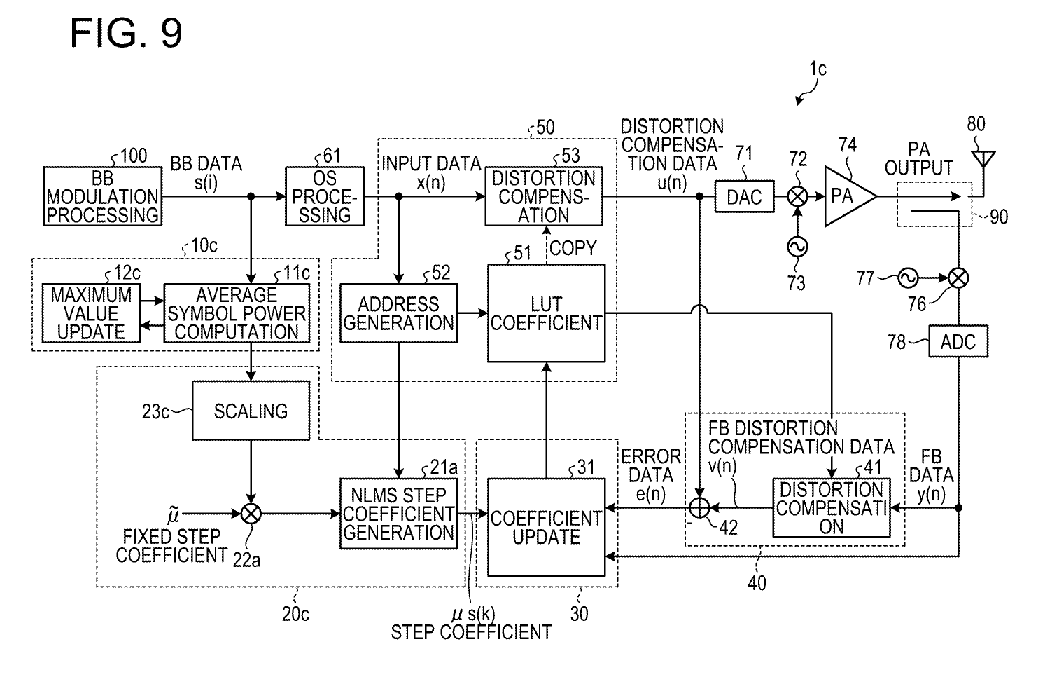

Alternatively, in a case where it is difficult to specify a symbol whose reference power is the maximum power, the distortion compensator 1b may sequentially retrieve the maximum value of the computed average power of the signal block so that the reference power becomes the maximum power at the present time. FIG. 9 is a view illustrating a specific configuration of a distortion compensator is according to a second modification of the above-described embodiment. Referring to FIG. 9, the distortion compensator 1c may include an arithmetic unit 10c as a specific configuration example of the acquiring unit 10 (see, e.g., FIG. 1). The arithmetic unit 10c includes an average symbol power arithmetic unit 11c and a maximum value updating unit 12c.

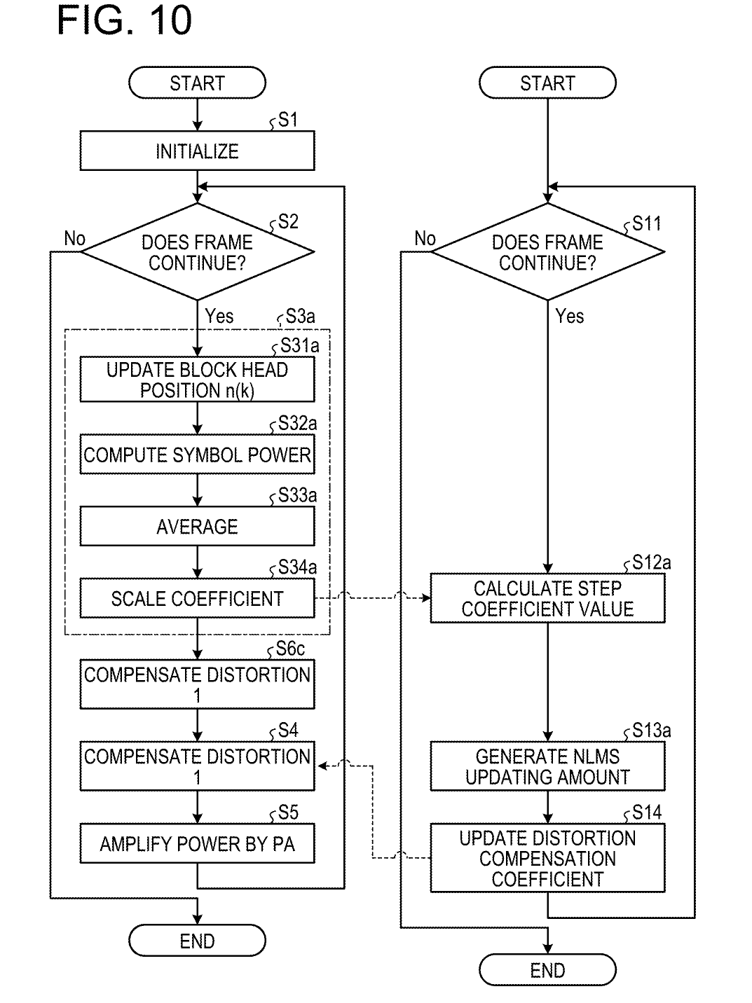

Further, the distortion compensator 1c performs an operation as illustrated in FIG. 10 as a specific operation example. FIG. 10 is a flowchart illustrating the specific operation of the distortion compensator 1c.

For example, the maximum value updating unit 12c acquires the average power <|s|²>ₙ₍ₖ₎ of the signal block (OFDM symbol) computed in S33a from the average symbol power arithmetic unit 11c. The maximum value updating unit 12c compares the value of the current reference power P_{ref} with the value of the average power <|s|²>ₙ₍ₖ₎ of the signal block. When P_{ref}≤<|s|²>ₙ₍ₖ₎, the maximum value updating unit 12c replaces and updates the value of P_{ref} with the value of <|s|²>ₙ₍ₖ₎. The maximum value updating unit 12c holds the updated reference power P_{ref}. The average symbol power arithmetic unit 11c may supply the reference power P_{ref} held in the maximum value updating unit 12c to the scaling unit 23c. The scaling unit 23c may use the updated reference power P_{ref} to obtain the scaling value mₛ(k).

Although it is illustrated in FIG. 10 that the maximum value updating (S6c) is performed after the coefficient scaling (S34a), the maximum value updating (S6c) may be performed before the coefficient scaling (S34a).

In this way, when it is difficult to specify the maximum value of the average power in a plurality of signal blocks, since the maximum value of the average power of the signal block is retrieved and updated, the coefficient scaling may be performed properly.

Third Modification

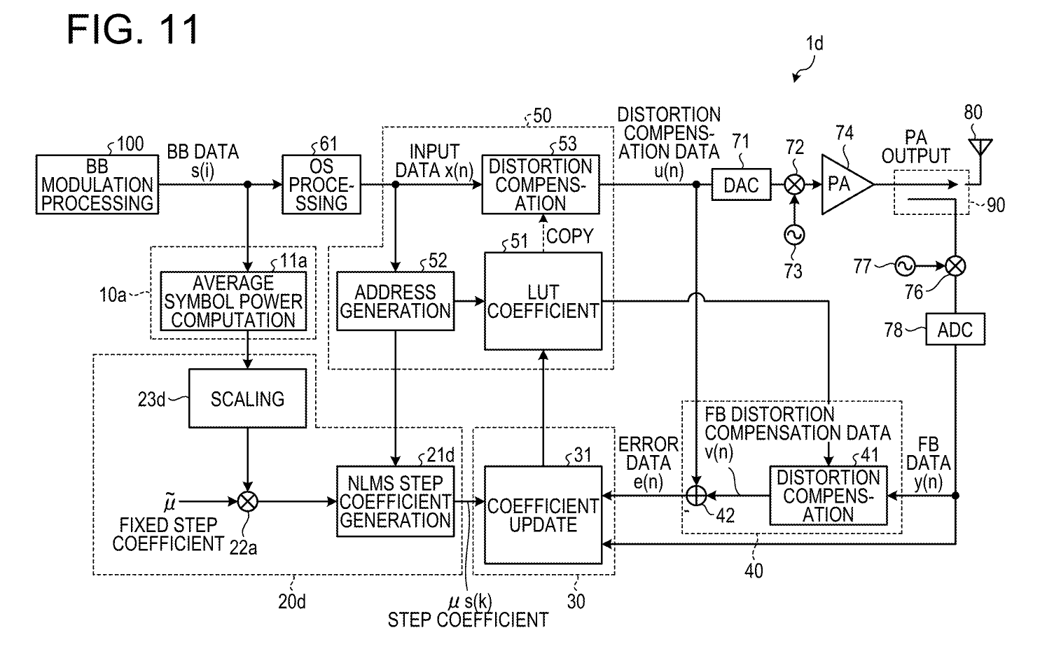

FIG. 11 is a view illustrating a specific configuration of a distortion compensator 1d. Referring to FIG. 11, the distortion compensator 1d may employ the LMS method as a method for generating the coefficient updating amount Δ_{Li,j}. As illustrated in FIG. 11, the distortion compensator 1d includes an arithmetic unit 10a and a calculating unit 20d as specific configuration examples of the acquiring unit 10 and the calculating unit 20 (see, e.g., FIG. 1). The arithmetic unit 10a includes an average symbol power arithmetic unit 11a. The calculating unit 20d includes an LMS step coefficient generating unit 21d, a multiplier 22a, and a scaling unit 23d.

The average symbol power arithmetic unit 11a may obtain the average power for the BB data s(i) in a period ranging from a head sample timing n(k) of the k-th OFDM symbol to a prescribed sample number Nₐᵥ, as illustrated in Equation (10). The average symbol power arithmetic unit 11a supplies the obtained average power to the scaling unit 23d.

The scaling unit 23 d obtains the scaling value mₛ(k) illustrated in the following Equation (16) before the head data of the k-th OFDM symbol interval with respect to the FB data y(n) begins.

$${m}_{s} ( k ) = \sqrt{\frac{{P}_{ref}}{ {\vert s \vert}^{2} {n ( k )}_{}}} \qquad ( 16 )$$

In Equation (16), P_{ref} represents the reference power. That is, the scaling unit 23d obtains the scaling value mₛ(k) corresponding to the relative value of the reciprocal of the average power <|s|²>ₙ₍ₖ₎ of the k-th OFDM symbol with respect to the reciprocal of the reference power P_{ref} according to the LMS method.

The multiplier 22a receives a fixed step coefficient (fixed coefficient value) ˜μ and receives the scaling value mₛ(k) from the scaling unit 23d. The multiplier 22a multiplies the fixed step coefficient ˜μ by the scaling value mₛ(k) to obtain the value of the step coefficient μₛ(k), as illustrated in the following Equation (13).

That is, the calculating unit 20a scales and calculates the scaling value mₛ(k) so as to make the coefficient updating amount ΔL_{i,j} substantially equal among the plurality of signal blocks. The multiplier 22a supplies the calculated scaling value mₛ(k) to the LMS step coefficient generating unit 21d. The LMS step coefficient generating unit 21d associates an address generated by the address generating unit 52 with the value of the step coefficient μₛ(k). The LMS step coefficient generating unit 21d supplies the step coefficient μₛ(k) associated with the address to the coefficient updater 31 of the updating unit 30.

The coefficient updater 31 generates the coefficient updating amount ΔL_{i,j} by performing a calculation expressed by the following Equation (17) instead of Equation (8).

ΔL_{i,j}=μₛ(k)·e(n)·y(n−j)* (17)

The calculation illustrated in Equation (17) is different from the calculation illustrated in Equation (8) in that the step coefficient μₛ(k) is variable. The coefficient updater 31 obtains the update value L_{i,j}(|x(n−i)|)′ of the LUT coefficient for each of i,j=0, 1, . . . , Q by performing the calculation illustrated in Equation (7).

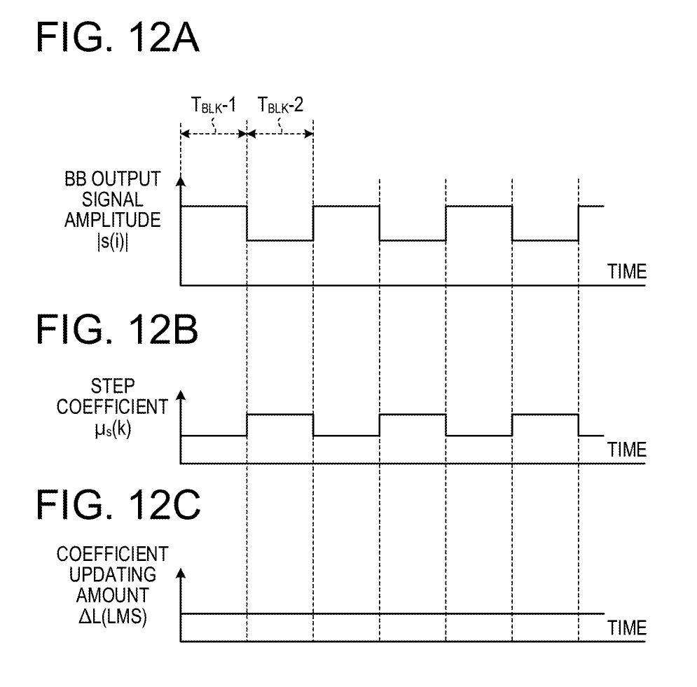

In the distortion compensator 1d, scaling dependent on the average power is performed on the fixed step coefficients ˜μ on a signal block basis to change the value of the step coefficient μₛ(k). That is, as illustrated in FIGS. 12A to 12C, the value of the step coefficient μₛ(k) is changed so as to make the coefficient updating amount ΔL_{i,j} substantially constant. FIGS. 12A to 12C are waveform diagrams illustrating a specific operation of the distortion compensator 1d.

When the amplitude |s(i)| of the BB data s(i) output from the BB modulation processing unit 100 is changed as illustrated in FIG. 12A, the scaling value mₛ(k) decreases as the amplitude |s(i)| becomes larger, as illustrated in Equation (16). The scaling value mₛ(k) increases as the amplitude |s(i)| becomes smaller, as illustrated in Equation (16). Therefore, the value of the step coefficient μₛ(k) is changed as illustrated in FIG. 12B in such a manner that it decreases as the amplitude |s(i)| becomes larger and increases as the amplitude |s(i)| becomes smaller, as illustrated in Equation (13).

That is, as in the case of the NLMS method (see, e.g., FIGS. 5A to 5C), depending on the average power of a signal block computed in a period corresponding to the signal block, the value of the step coefficient μₛ(k) may be changed at a timing corresponding to the boundary between signal blocks immediately after the signal block. As a result, as illustrated in Equations (16) and (14), since the power for normalizing the coefficient updating amount ΔL_{i,j} is substantially maintained at the value of the reference power P_{ref}, the coefficient updating amount ΔL_{i,j} may be maintained substantially constant, as illustrated in FIG. 12C.

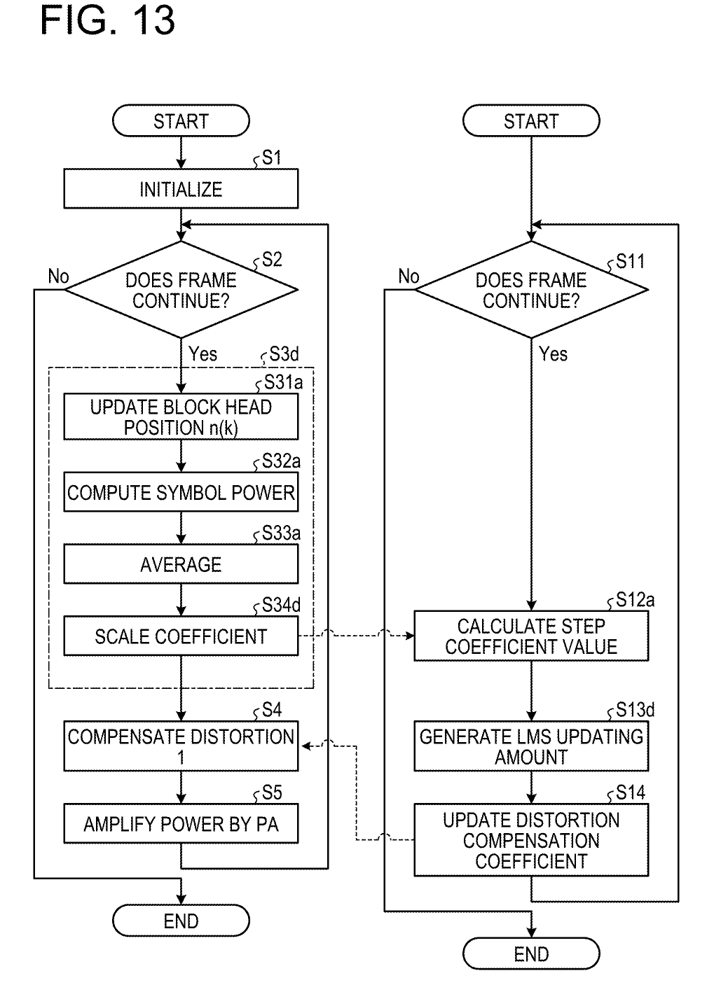

In addition, the distortion compensator 1d basically performs the same operation as in FIG. 6, but operates differently from that of the embodiment in the following points as illustrated in FIG. 13. FIG. 13 is a flowchart illustrating a specific operation of the distortion compensator 1d.

In average symbol power computation (S3d), the arithmetic unit 10a uses the average power <|s|²>ₙ₍ₖ₎ to obtain the scaling value mₛ(k), as illustrated in Equation (16), and supplies the obtained scaling value mₛ(k) to the calculating unit 20d (S34d).

When it is determined that a frame continues (“Yes” in S11), the calculating unit 20d multiplies the fixed step coefficient ˜μ by the scaling value mₛ(k) to calculate the value of the step coefficient μₛ(k) (S12a). The calculating unit 20d supplies the calculated value of the step coefficient μₛ(k) to the updating unit 30.

As illustrated in Equation (17), according to the LMS method, the updating unit 30 obtains the coefficient updating amount ΔL_{i,j} corresponding to the value of the step coefficient μₛ(k) (S13d). The updating unit 30 accesses the LUT 51 to update the LUT coefficient (distortion compensation coefficient) L_{i,j} with the obtained coefficient updating amount ΔL_{i,j} (S14).

In this manner, when the LMS method is adopted as a method for generating the coefficient updating amount ΔL_{i,j}, the average power of the transmission signal obtained for each signal block is used to scale the value of the step coefficient μₛ(k) so as to make the coefficient updating amount ΔL_{i,j} constant. Then, the distortion compensation coefficient L_{i,j} is updated with the coefficient updating amount ΔL_{i,j} obtained from the step coefficient μₛ(k). Accordingly, when the power of the transmission signal (the power of the input data) is greatly changed, the variation of the coefficient updating amount ΔL_{i,j} may be suppressed, thereby suppressing the variation of the distortion compensation coefficient to be updated.

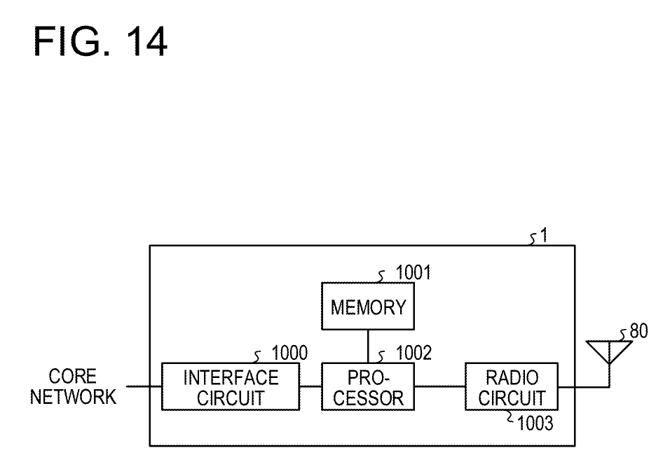

The distortion compensator 1 (1a to 1d) of each of the above-described embodiment and modifications thereof is implemented with, for example, hardware as illustrated in FIG. 14 which is a view illustrating one example of hardware of the distortion compensator 1. For example, as illustrated in FIG. 14, the distortion compensator 1 includes an interface circuit 1000, a memory 1001, a processor 1002, a radio circuit 1003, and an antenna 80.

The interface circuit 1000 is an interface for connecting to a core network by wired connection and implements the function of the BB modulation processing unit 100. The radio circuit 1003 performs a process such as up-conversion on a signal output from the processor 1002 and transmits the processed signal via the antenna 80. Further, the radio circuit 1003 includes the PA 74, performs a process such as down-conversion on a portion of the signal output from the PA 74, and feeds back the down-converted signal to the processor 1002. The radio circuit 1003 implements the function of the RF digital unit 60.

The memory 1001 stores, for example, various programs for implementing each function of the RF digital unit 60. By executing the programs read from the memory 1001, the processor 1002 implements each function of, for example, the RF digital unit 60. Although it is illustrated in FIG. 14 that the distortion compensator 1 includes one processor 1002, the distortion compensator 1 may include more processors 1002.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to an illustrating of the superiority and inferiority of the invention. Although the embodiments of the present invention have been described in detail, it should be understood that the various changes, substitutions, and alterations could be made hereto without departing from the spirit and scope of the invention.

What is claimed is:

1. A distortion compensation apparatus for compensating a distortion of a power amplifier configured to amplify a transmission signal, the distortion compensation apparatus comprising:
a memory; and
a processor coupled to the memory and the processor configured to:
acquire an average power of the transmission signal including a plurality of signal blocks by a signal block of the plurality of signal blocks;
calculate a step coefficient value based on the acquired average power; and
update a distortion compensation coefficient for compensating the distortion, based on an updating amount according to the calculated step coefficient value.

2. The distortion compensation apparatus according to claim 1,
wherein the processor is configured to:
acquire the average power for each of the plurality of signal blocks,
calculate the step coefficient value for each of the plurality of signal blocks, based on the acquired average power, and
update the distortion compensation coefficient for each of the plurality of signal blocks, based on the updating amount according to the calculated step coefficient value.

3. The distortion compensation apparatus according to claim 2,
wherein the processor is configured to update the distortion compensation coefficient with the updating amount according to the calculated step coefficient value at a timing corresponding to a boundary between the plurality of signal blocks.

4. The distortion compensation apparatus according to claim 2,
wherein the processor configured to calculate the step coefficient value so as to make the updating amount equivalent among the plurality of signal blocks, based on the acquired average power.

5. The distortion compensation apparatus according to claim 1,
wherein the processor configured to calculate the step coefficient value by multiplying a value according to the acquired average power to a fixed coefficient value.

6. The distortion compensation apparatus according to claim 1,
wherein the processor is configured to calculate the step coefficient value by multiplying a value according to a reciprocal number of the acquired average power to a fixed coefficient value.

7. The distortion compensation apparatus according to claim 5,
wherein the processor is configured to:
obtain a scaling value corresponding to a relative value of the acquired average power with respect to a reference power, and
multiply the obtained scaling value, to the fixed coefficient so as to calculate the step coefficient value.

8. The distortion compensation apparatus according to claim 6,
wherein the processor is configured to:
obtain a scaling value corresponding to a relative value of the reciprocal number of the acquired average power with respect to a reference power, and
multiply the obtained scaling value, to the fixed coefficient so as to calculate the step coefficient value.

9. The distortion compensation apparatus according to claim 7,
wherein the reference power is a maximum value of the average power among the plurality of signal blocks.

10. The distortion compensation apparatus according to claim 7,
wherein the reference power is updated to the value of the acquired average power when the acquired average power is larger than the reference power.

11. A distortion compensation method for compensating a distortion of a power amplifier configured to amplify a transmission signal, the distortion compensation method comprising:
acquiring an average power of the transmission signal including a plurality of signal blocks by a signal block of the plurality of signal blocks;
calculating a step coefficient value based on the acquired average power; and
updating a distortion compensation coefficient for compensating the distortion, based on an updating amount according to the calculated step coefficient value, by a processor.
